(19) United States
(12) Patent Application Publication
(10) Pub. No.: US 2024/0172085 A1
(43) Pub. Date: May 23, 2024

(54) DATA TRANSFER SCHEMES IN WIRELESS COMMUNICATIONS

(71) Applicant: ZTE Corporation, Shenzhen (CN)

(72) Inventors: Xueying DIAO, Shenzhen (CN); Lin CHEN, Shenzhen (CN); Ying HUANG, Shenzhen (CN)

(21) Appl. No.: 18/430,441

(22) Filed: Feb. 1, 2024

Related U.S. Application Data
(63) Continuation of application No. PCT/CN2021/110179, filed on Aug. 3, 2021.

(51) Int. Cl. H04W 40/22

(52) U.S. Cl. CPC H04W 40/22

(57) ABSTRACT

Methods, systems, apparatus for wireless communication are described. A method of wireless communication is provided to include performing, by a first node of an integrated access and backhaul (IAB) network, a data transmission with a second node in the IAB. In addition, apparatus for implementing the method is also described.

### CROSS REFERENCE TO RELATED APPLICATIONS

This patent document is a continuation of and claims benefit of priority to International Patent Application No. PCT/CN2021/110179, filed on Aug. 3, 2021. The entire content of the before-mentioned patent application is incorporated by reference as part of the disclosure of this application.

### TECHNICAL FIELD

This patent document generally relates to systems, devices, and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices.

### SUMMARY

This document relates to methods, systems, and devices for data transfer schemes in wireless communications.

In one aspect, a wireless communication method is disclosed. The method performing, by a first node of an integrated access and backhaul (IAB) network, a data transmission with a second node in the IAB.

In another aspect, a wireless communication method is disclosed. The method includes configuring, by a first node of an integrated access and backhaul (IAB) network connected to a second node of the IAB network, a packet transmission that is routable to a third node of the IAB network.

In another aspect, a wireless communication method is disclosed. The method includes configuring, by a central unit of an IAB (integrated access and backhaul) donor, a distributed unit of the IAB-donor to allow a packet transmission to be routable via the distributed unit of the IAB-donor.

These, and other features, are described in the present document.

### BRIEF DESCRIPTION OF THE DRAWING

FIG. 1 an example of a network deployed with integrated access and backhaul links.

FIG. 2 shows an example of an inter donor scenario of an IAB topology including multiple IAB nodes and IAB donors.

FIG. 3 shows an example of a intra donor scenario of an IAB topology including multiple IAB nodes and IAB donors.

FIG. 4 shows an example of a diagram illustrating an IP-based tunneling between a control unit and a boundary node in an IAB network.

FIG. 5 shows an example of a diagram illustrating a GTP-U tunnel between a 1st donor DU and a 2nd donor DU based on some implementations of the disclosed technology.

FIG. 6 shows an example of wireless communication including a base station (BS) and user equipment (UE) based on some implementations of the disclosed technology.

FIG. 7 shows an example of a block diagram of a portion of an apparatus based on some implementations of the disclosed technology.

FIGS. 8A to 8C illustrate flowcharts showing example methods of wireless communication based on some implementations of the disclosed technology.

### DETAILED DESCRIPTION

The disclosed technology provides implementations and examples of resource coordination schemes in wireless communications.

Integrated access and backhaul (IAB) supports wireless backhauling via new radio (NR) enabling flexible and very dense deployment of NR cells while reducing the need for wireline transport infrastructure. Compared with LTE, NR has a larger available bandwidth. The use of massive MIMO and multi-beam makes the research and application of IAB links possible. Through wireless backhaul links and relay links, dense NR cell networks can be deployed with more flexible without the need to increase the dense deployment of transmission networks accordingly.

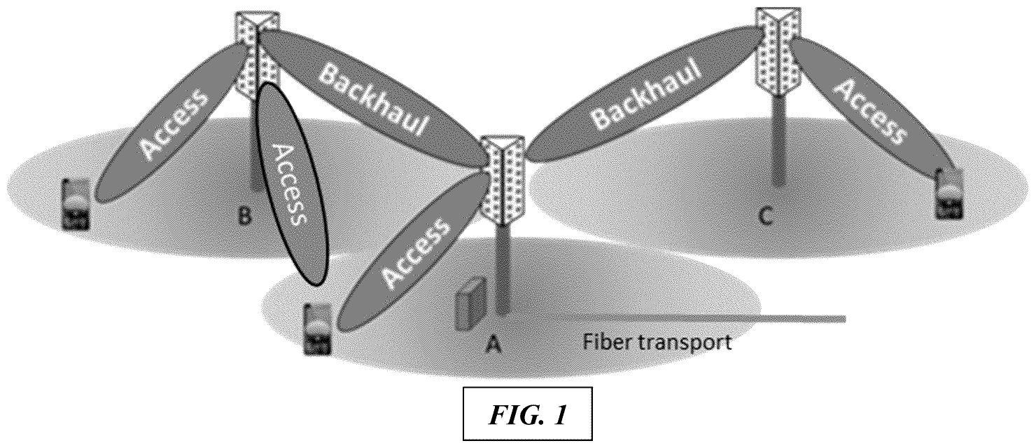

FIG. 1 shows an example of a network deployed with integrated access and backhaul links. In FIGS. 1, A, B, and C are all access nodes, and user equipment can access nodes A, B, C through access links. There is only a wired connection between the access node A and the core network, and the access nodes B and C have no wired connection with the core network element. Among them, the access node that supports the wireless access of the UE and performs wireless backhaul of data is called an IAB node. The access node that provides the wireless backhaul function for the IAB node to connect the UE to the core network is called an IAB donor (IAB donor).

The data of the UE can be transmitted between the access nodes through the wireless backhaul link. For example, the access node B may send the data received from the UE to the access node A through a wireless backhaul link, and then the access node A sends the UE data to the core network element. For the downlink, the core network element can send the UE data packet to the access node A, and then the access node A sends the UE data to the access node B through the wireless backhaul link, and the access node B sends the UE through the access link so that the data is sent to the UE. The access link and the backhaul link can use the same or different carrier frequencies. In addition, the data of the UE may need to be transmitted through the multi-hop relay backhaul link between the access node and the core network.

Supporting the separate deployment of a central unit (CU)/distributed unit (DU) and/or supporting an IAB function in CU/DU separated deployment scenario is an important technical aspects in NR. Currently, it is not always available for an IAB donor-DU to forward a packet with IP address not in its subnet, where the IP address is a source IP address and/or a destination IP address. Implementations of the disclosed technology provide mechanisms to enable such IP packet transmission over the donor-DU.

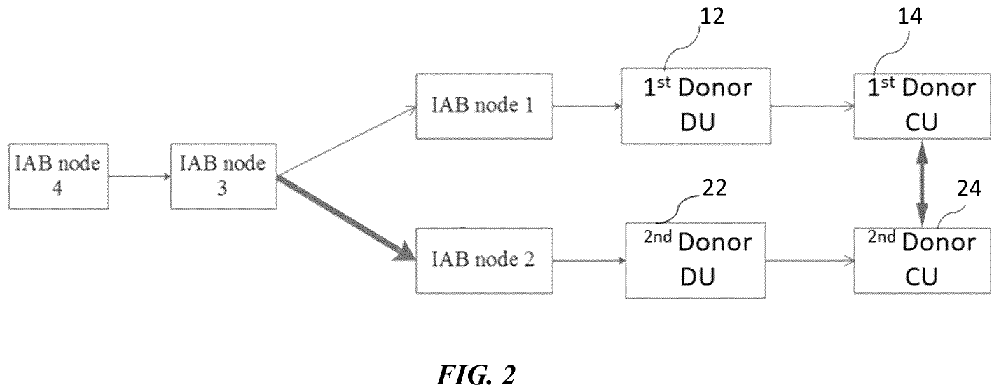

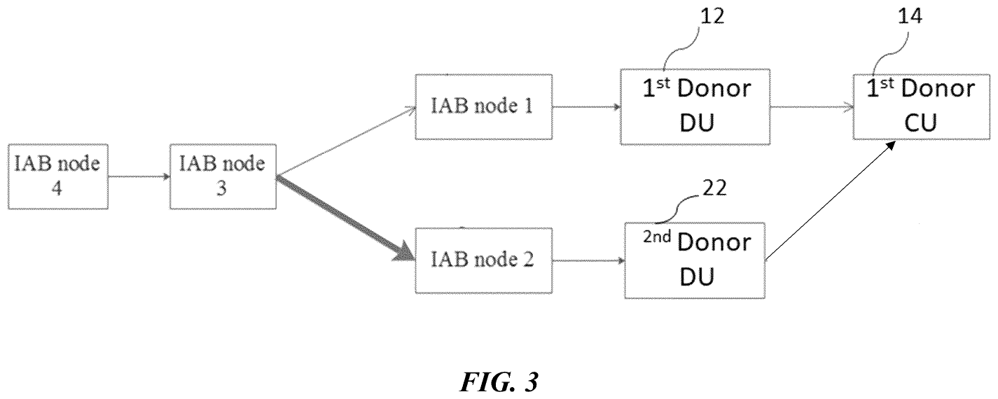

Various implementations discussed in this patent document can be applied to an IAB topology as shown in FIGS. 2 and 3. FIG. 2 illustrates the inter-donor scenario (data transmission between donor DUs belonging to different donor CUs) and FIG. 3 illustrates the intra-donor scenario (data transmission between donor DUs belonging to the same donor CU). Thus, the techniques discussed in this patent document can be applied to the inter donor scenario and intra-donor scenario. Although not separately mentioned, the reference numbers used in the descriptions of each implementation can designate corresponding elements with such reference numbers in both FIGS. 2 and 3.

In FIGS. 2 and 3, the IAB network comprises a plurality of IAB nodes (e.g., IAB nodes 1 to 4) to operate as relays between IAB donors and UEs. Each IAB donor comprises a central unit (CU) and a distributed unit (DU). The IAB donor DUs can be configured to access a same donor CU or different donor CUs. In FIG. 2, a first donor DU 12 is connected with a first donor CU 14 and a second donor DU 22 is connected with a second donor CU 24. In FIG. 3, a first donor DU 12 and a second donor DU 22 are connected with a first donor CU 14. In this patent document, the connection between nodes can refer to communication capabilities between the nodes.

The IAB node 3 is originally connected with the IAB node 1 (hereinafter “first IAB node”) that is connected with the first IAB donor DU 12 and the first IAB donor CU 14. Under some circumstances, the first IAB donor CU 14 may decide the data transmission of a packet originally scheduled to the first IAB donor CU 14 to be routed to the IAB node 2 that is connected with the second IAB donor DU 22. After the routing to the second IAB donor DU 22, the traffic received from the IAB node 4 is transferred to the second IAB donor DU 22 instead of the first IAB donor DU 12. The disclosed technology provide various implementations to assist the data transmission via the second IAB donor. Although the IP-based tunneling is discussed in the below as the example of the data transmission, the data transmission is not limited thereto and the implementations of the disclosed technology can be applied to various transmission techniques in wireless communications.

Implementation 1

This implementation proposes to establish an IP-based tunneling between the 1st IAB donor DU 12 and the 2nd IAB donor DU 22 to enable data transfer via the 2nd IAB donor DU 22. The techniques discussed in this implementation can be applied to the IAB topology shown in FIGS. 2 and 3.

The IAB donor CU may send a configuration to the IAB donor DU, which includes the mapping between an identity of the neighboring IAB donor DU and the belonging IP subnet or the IP prefix or IP addresses of the neighboring IAB donor DU. In some implementations, the IAB donor CU may send an indication to the IAB donor DU that the packet with such IP information can be transferred through the tunnel between the donor DU and the neighboring donor DU.

Downlink (DL)

Step 1: The 1st IAB-donor CU-CP (a control plane of the 1st IAB-donor-CU 14) may send, to the 2nd IAB-donor-CU 24, at least one of following information:
an IP (source) address and an indication indicating that the IP address is the source IP address used by the DL packet transferred via the tunnel between the 1st IAB-donor-DU 12 and the 2nd IAB-donor-DU 22.
an identity of the 2nd IAB-donor-DU 22
an identity of the 1st IAB-donor-DU 12

Step 2: The 2nd IAB-donor-CU 24 may send, to the 2nd IAB-donor-DU 22, at least one of following information:
an IP (source) address and an indication indicating that the IP address is the source IP address used by the DL packet transferred via the tunnel between the 1st IAB-donor-DU 12 and the 2nd IAB-donor-DU 22.
an identity of the 1st IAB-donor-DU 12

Step 3: The 2nd IAB-donor-DU 22 may send, to the 2nd IAB-donor-CU 24, at least one of following information:
an IP (destination) address and an indication indicating that the IP address is the destination IP address used by the DL packet transferred via the tunnel between the 1st IAB-donor-DU 12 and the 2nd IAB-donor-DU 22.
an identity of the 1st IAB-donor-DU 12

Step 4: The 2nd IAB-donor-CU 24 may send, to the 1st IAB-donor CU-CP, at least one of following information:
an IP (destination) address and an indication indicating that the IP address is the destination IP address used by the DL packet transferred via the tunnel between the 1st IAB-donor-DU 12 and the 2nd IAB-donor-DU 22.
an identity of the 1st IAB-donor-DU 12
an identity of the 2nd IAB-donor-DU 22

Step 5: The 1st donor CU 14 may configure data transmission to support the data transfer via the second IAB donor DU 22. In some implementations, the 1st IAB-donor-CU 14 updates the Downlink Traffic to Routing ID Mapping Configuration for the 1st IAB-donor-DU 12. In some implementation, such update may be done by removing the entries related to the migrated packets. In some implementations, the 1st IAB-donor-CU 14 sends, to the 1st IAB-donor-DU 12, the data transmission configuration. Each entry of the data transmission configuration contains at least one of the following items:
a destination IP address, which is indicated by Destination IAB TNL (transport network layer) Address IE in IP header information IE, including an IPv4 address or IPv6 address or an IPv6 address prefix
an IPv6 flow label, if configured, which is indicated by IPv6 Flow Label IE in IP header information IE
a differentiated services code point (DSCP), if configured, which is indicated by DSCP IE in DS Information List IE in IP header information IE
an indication about whether the packet needs to be transmitted via an tunnel between the 1st IAB-donor-DU 12 and the 2nd IAB-donor-DU 22.
a destination IP address used for the packet when transmitted via an tunnel between the 1st IAB-donor-DU 12 and the 2nd IAB-donor-DU 22.
a source IP address used for the packet when transmitted via an tunnel between the 1st IAB-donor-DU 12 and the 2nd IAB-donor-DU 22.
an identity of the 2nd donor DU 22

Uplink (UL)

Step 1: The 1st IAB-donor CU-CP may send, to the 2nd IAB-donor-CU 24, at least one of following information:
an IP (destination) address and an indication indicating that the IP address is the destination IP address used by the UL packet transferred via the tunnel between the 1st IAB-donor-DU 12 and the 2nd IAB-donor-DU 22.
an identity of the 2nd IAB-donor-DU 22
an identity of the 1st IAB-donor-DU 12

Step 2: The 2nd IAB-donor-CU 24 may send, to the 2nd IAB-donor-DU 22, at least one of the following information:
an IP (destination) address and an indication indicating that the IP address is the destination IP address used by the UL packet transferred via the tunnel between the 1st IAB-donor-DU 12 and the 2nd IAB-donor-DU 22.
an identity of the 1st IAB-donor-DU 12
the source IP addresses of the migrated UL packets, and optionally an indication. The indication is used to inform the 2nd IAB-donor-DU 22 that UL packets with the source IP addresses needs to be allowed to be transferred via the tunnel between the 1st IAB-donor-DU 12 and the 2nd IAB-donor-DU 22.

Step 3: The 2nd IAB-donor-DU 22 may send, to the 2nd IAB-donor-CU, at least one of the following information:
an IP (source) address and an indication indicating that the IP address is the source IP address used by the UL packet transferred via the tunnel between the 1st IAB-donor-DU 12 and the 2nd IAB-donor-DU 22.
an identity of the 1st IAB-donor-DU 12

Step 4: The 2nd IAB-donor-CU 24 may send, to the 1st IAB-donor CU, at least one of the following information:
an IP (source) address and an indication indicating that the IP address is the source IP address used by the UL packet transferred via the tunnel between the 1st IAB-donor-DU 12 and the 2nd IAB-donor-DU 22.
an identity of the 2nd IAB-donor-DU 22
an identity of the 1st IAB-donor-DU 12

Step 5: The 1st IAB-donor CU may send, to the 1st IAB-donor-DU 12, at least one of the following information:
an IP (source) address and an indication indicating that the IP address is the source IP address used by the UL packet transferred via the tunnel between the 1st IAB-donor DU 12 and the 2nd IAB-donor-DU 22.
an identity of the 2nd IAB-donor-DU 22

Step 6: The descendant node (the IAB node 3) still uses the previous IP address, which is in the 1st IAB-donor-DU domain, to encapsulate the UL packet. After receiving such packet, the 2nd IAB-donor-DU 22 can recognize that the source IP address is not in its own IP subnet but in the 1st IAB-donor-DU domain. Then the packet will be delivered to the 1st IAB-donor-DU via IP tunneling.

Implementation 2

This implementation proposes to establish an IP-based tunneling between the 1st IAB-donor-CU 14 and the 2nd IAB-donor-DU 22 to enable the data transfer via the 2nd IAB-donor-DU 22. The 1st donor CU 14 comprises the 1st donor CU-CP (control plane) and the 1st donor CU-UP (user plane).

Downlink (DL)

Step 1: The 1st IAB-donor CU-CP may send, to the 2nd IAB-donor-CU 24, at least one of the following information:
an IP (source) address and an indication indicating that the IP address is the source IP address used by the DL packet transferred via the tunnel between the 1st IAB-donor CU-UP and the 2nd IAB-donor-DU 22.
an identity of the 2nd IAB-donor-DU 22
an identity of the 1st IAB-donor CU-UP

Step 2: The 2nd IAB-donor-CU 24 may send, to the 2nd IAB-donor-DU, at least one of the following information:
an IP (source) address and an indication indicating that the IP address is the source IP address used by the DL packet transferred via the tunnel between the 1st IAB-donor CU-UP and the 2nd IAB-donor-DU 22.
an identity of the 1st IAB-donor CU-UP

Step 3: The 2nd IAB-donor-DU 22 may send, to the 2nd IAB-donor-CU 24, at least one of the following information:
an IP (destination) address and an indication indicating that the IP address is the destination IP address used by the DL packet transferred via the tunnel between the 1st IAB-donor CU-UP and the 2nd IAB-donor-DU 22.
an identity of the 1st IAB-donor CU-UP

Step 4: The 2nd IAB-donor-CU 24 may send, to the 1st IAB-donor CU-CP, at least one of the following information:
an IP (destination) address and an indication indicating that the IP address is the destination IP address used by the DL packet transferred via the tunnel between the 1st IAB-donor CU-UP and the 2nd IAB-donor-DU 22.
an identity of the 1st IAB-donor CU-UP
an identity of the 2nd IAB-donor-DU 22

Step 5: the 1st IAB-donor CU-UP does not know whether a packet needs to be delivered via an IP tunnel. So the 1st IAB-donor CU-CP may need to configure the 1st IAB-donor CU-UP the downlink traffic via IP tunnel configuration, which includes at least one of the following items:
F1-U tunnel identity, The F1-U tunnel identity can be represented using i) an UE identity and a DRB (dedicated radio bearer) identity or ii) a Transport Layer Address and a GTP Tunnel Endpoint Identifier.
the identity of the 2nd IAB-donor-DU 22.
an indication about whether the packet needs to be transmitted via a tunnel between the 1st IAB-donor CU-UP and the 2nd IAB-donor-DU 22.
the destination IP address used for the packet when transmitted via a tunnel between the 1st IAB-donor CU-UP and the 2nd IAB-donor-DU 22.
the source IP address used for the packet when transmitted via a tunnel between the 1st IAB-donor CU-UP and the 2nd IAB-donor-DU 22.
a destination IP address, which is indicated by Destination IAB TNL Address IE in IP header information IE, including an IPv4 address or IPv6 address or an IPv6 address prefix
an IPv6 flow label, if configured, which is indicated by IPv6 Flow Label IE in IP header information IE,
a DSCP, if configured, which is indicated by DSCP IE in DS Information List IE in IP header information IE.

Each items above is optional and can be included in or omitted from the configuration based on implementations.

Uplink (UL)

Step 1: The 1st IAB-donor CU-CP may send, to the 2nd IAB-donor-CU 24, at least one of the following information:
an IP (destination) address and an indication indicating that the IP address is the destination IP address used by the UL packet transferred via the tunnel between the 1st IAB-donor CU-UP and the 2nd IAB-donor-DU 22.
an identity of the 2nd IAB-donor-DU 22
an identity of the 1st IAB-donor CU-UP

Step 2: The 2nd IAB-donor-CU 24 may send, to the 2nd IAB-donor-DU 22, at least one of the following information:
an IP (destination) address and an indication indicating that the IP address is the destination IP address used by the UL packet transferred via the tunnel between the 1st IAB-donor CU-UP and the 2nd IAB-donor-DU 22.
an identity of the 1st IAB-donor CU-UP
the source IP addresses of the migrated UL packets, and optionally an indication. The indication is used to inform the 2nd IAB-donor-DU 22 that UL packets with the source IP addresses should be allowed to be transferred via the tunnel between the 1st IAB-donor CU-UP and the 2nd IAB-donor-DU 22.

Step 3: The 2nd IAB-donor-DU 22 may send, to the 2nd IAB-donor-CU 24, at least one of the following information:
an IP (source) address and an indication indicating that the IP address is the source IP address used by the UL packet transferred via the tunnel between the 1st IAB-donor-DU 12 and the 2nd IAB-donor-DU 22.
an identity of the 1st IAB-donor-CU-UP

Step 4: The 2nd IAB-donor-CU may send, to the 1st IAB-donor CU-CP, at least one of the following information:
an IP (source) address and an indication indicating that the IP address is the source IP address used by the UL packet transferred via the tunnel between the 1st IAB-donor CU-UP and the 2nd IAB-donor-DU.
an identity of the 2nd IAB-donor-DU 22
an identity of the 1st IAB-donor CU-UP

Step 5: The 1st IAB-donor CU-CP may send, to the 1st IAB-donor CU-UP, at least one of the following information:
an IP address and an indication indicating that the IP address is the source IP address used by the UL packet transferred via the tunnel between the 1st IAB-donor CU-UP and the 2nd IAB-donor-DU 22.
an identity of the 2nd IAB-donor-DU 22

Step 6: The descendant node still uses the previous IP address, which is in the 1st IAB-donor-DU domain, to encapsulate the UL packet. After receiving such packet, the 2nd IAB-donor-DU 22 can recognize that the source IP address is not in its own IP subnet but the packet can be delivered to the 1st donor CU-UP via IP tunneling.

Implementation 3

This implementation focuses on the DL packet transmission from the 2nd donor DU 22 to the descendant node. The 1st donor CU 14 provides the 2nd donor CU 24 with the IP information of DL packets, e.g. the belonging IP subnet or the IP prefix or IP addresses of the DL packet. Then, the 2nd donor CU 24 sends the 2nd donor DU 22 the IP information. In some implementations, the 2nd donor CU 24 sends an indication to inform the 2nd donor DU 22 that DL packets with the IP information need to be allowed to be routed. In some implementations, the 1st donor CU 22 sends an indication to inform the second donor DU 22 that DL packets with the IP information need to be allowed to be routed.

Implementation 4

This implementation focuses on the DL packet transmission from the 2nd donor DU 22 to the descendant node. The 2nd donor DU 22 allocates new IP addresses, and 1st donor-CU uses the new IP addresses to encapsulate DL packets, but the new IP addresses are not configured to the descendant node. As a result, the descendant node would discard these DL packets. To solve this problem, the first donor CU 12 provides the descendant node with the IP information of the DL packets, where the IP address information can be IP addresses, or IP prefixes or IP subnets identity. In some implementations, an indication, which informs the descendant node that DL packets with the IP information need to be allowed to be routed.

Implementation 5

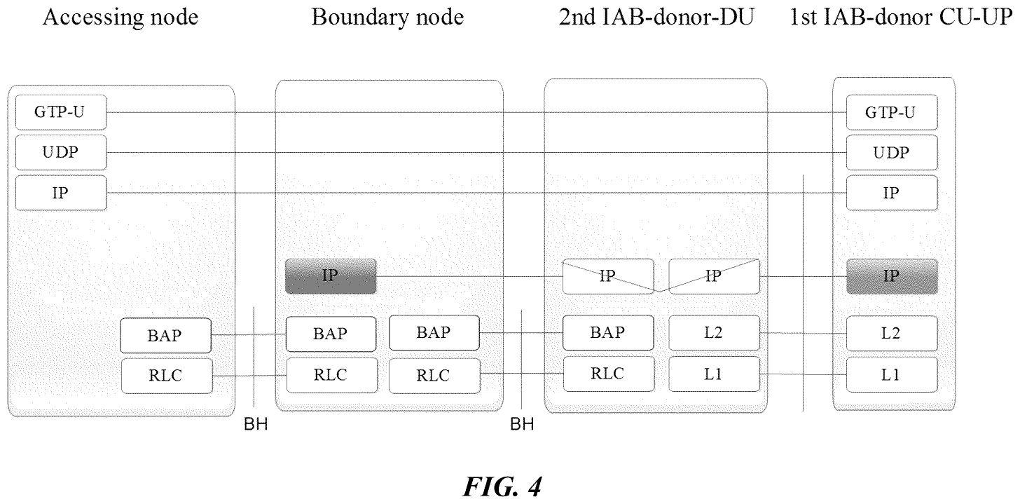

This implementation proposes establishing an IP-based tunneling between the source CU (e.g., the first donor CU 14 in FIG. 2 or 3) and the boundary node (e.g., the IAB node 3 in FIG. 2 or 3). The example diagram is illustrated in FIG. 4.

In DL, the additional IP header is added by the 1st donor CU-UP or CU-CP and is removed by the boundary node.

In UL, the boundary node adds an additional IP header to the packet received from its child node (e.g., the IAB node 4 in FIG. 2 or 3), and the 1st donor CU-UP or CU-CP removes the IP header.

In both DL and UL scenarios, the IP address in the additional IP header is routable via the 2nd donor DU 22.

The boundary node, as an intermediate IAB node, needs to support IP header addition/removal. In some implementations, not all the DL/UL packet requires to be added/removed the additional IP header, and thus the IAB-donor CU-CP needs to inform the IAB-donor CU-UP the packet requiring additional IP header adding or removal.

Assume that the traffic of an F1-U tunnel is routed via the 2nd donor DU 22. The 1st donor CU-CP may send the 1st donor CU-UP the IP address of the F1-U tunnel, which is in the second donor DU's IP domain, together with an indication to inform the 1st donor CU-UP that the packet from the F1-U tunnel requires additional IP header adding or removal. The 1st donor CU-CP may send another indication to inform the 1st donor CU-UP that the IP address is the destination IP address of the additional IP header for the DL IP packet.

In some implementations, the boundary IAB node (e.g., IAB node 3 in FIG. 2 or 3) can report the 1st donor CU 14 whether it supports an additional IP header removal via RRC message or F1AP message. The 1st donor CU 14 can configure the IAB node to activate additional IP header addition and removal via RRC message or F1AP message. The 1st donor CU-CP configures the boundary node which UE bearer needs additional IP header addition/removal.

In some implementations, the 1st donor CU 14 can send, to the boundary IAB node, a backhaul adaptation protocol (BAP) address of a child node together with an indication informing that the packet from/to the child node needs additional IP header addition/removal. The child-node BAP address can be used to identify the child node of the boundary node. In some implementations, the 1st donor CU 14 can send, to the boundary IAB node, a UL/DL ingress BH RLC channel together with an indication informing that the packet from the UL/DL ingress BH RLC channel needs additional IP header addition/removal. In some implementations, the 1st donor CU 14 can send, to the boundary IAB node, a UL/DL egress BH RLC channel together with an indication informing that the packet to the UL/DL egress BH RLC channel needs additional IP header addition/removal. In some implementations, the 1st donor CU 14 can send, to the boundary IAB node, a routing ID and an indication informing that the packet with the routing ID needs additional IP header addition/removal. In some implementations, the 1st donor CU 14 can send, to the boundary IAB node, at least one of a UE bearer identity, an indication indicating that the packet from the UE bearer needs the adding or the removing of the packet header.

In some implementations, all the UL packets delivered to the second parent node need additional IP header addition.

In some implementations, the DL packet from the second parent node and to be forwarded needs additional IP header removal.

In some implementations, the 1st donor CU 14 indicates the boundary node which IP address(es) is used for additional IP header addition. Alternatively, the boundary node may decide the IP address by itself.

Implementation 6

This implementation discusses IP address rewritten by a second donor DU (e.g., the second donor DU 22 in FIG. 2 or 3).

The first donor CU 12 uses the IP addresses anchoring to the second donor DU 22 for packet transmission. When the second donor DU 22 receives one or more those packets, it replaces those IP addresses by the ones used by descendant nodes (e.g., the IAB node 4) which are anchored at the first donor DU 12.

The second donor CU 24 configures the IP address mapping for the second donor DU 22. The IP address mapping configured by the second donor CU 24 includes at least one of the following:
a destination IP address, which is indicated by Destination IAB TNL Address IE in IP header information IE, including an IPv4 address or IPv6 address or an IPv6 address prefix,
an IPv6 flow label, if configured, which is indicated by IPv6 Flow Label IE in IP header information IE,
a DSCP, if configured, which is indicated by DSCP IE in DS Information List IE in IP header information IE, and
an IP address to be re-written.

Each items above is optional and can be included in or omitted from the configuration based on implementations. By configuring the IP address mapping including the above information, the second donor CU 24 informs the second donor DU 22 that the IP address needs to be rewritten for the packet with the above information. The IP address to be rewritten is also sent by the second donor CU 24 to the second donor DU 22. When receiving a downlink (DL) packet, the second donor DU 22 replaces the source IP address with the new IP address (e.g., the IP address to be re-written).

Implementation 7

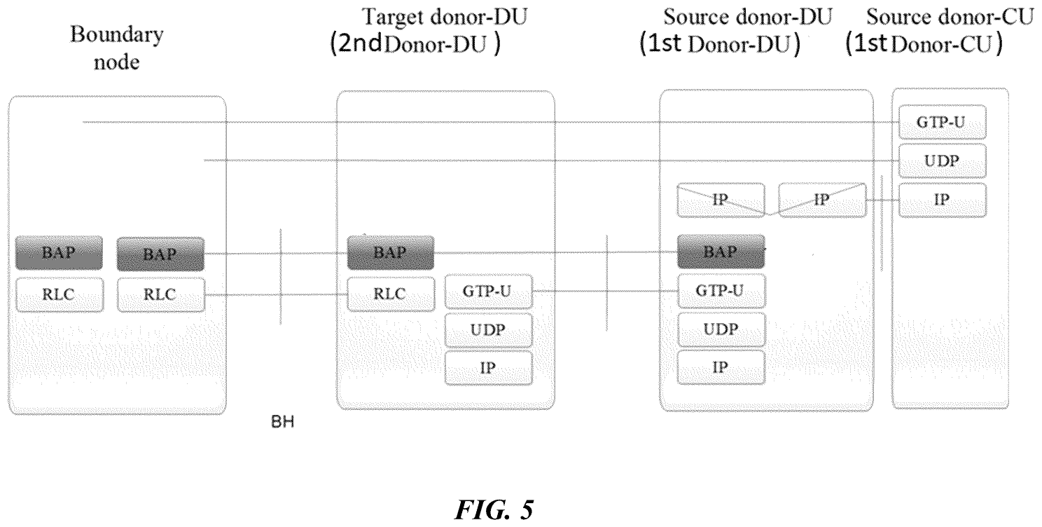

Implementation 7 will be discussed with reference to FIG. 5. The GPRS tunneling protocol user plane (GTP-U) tunnels are set up between the 1st donor DU (e.g., the first donor DU 12) and the 2nd donor DU (e.g., the second donor DU 22) to transmit packets with BAP header.

The 1st donor CU 14 determines to set up GTP-U tunnel between the first donor DU 12 and the second donor DU 22. Alternatively, the first donor CU 14 sends an F1AP message to the first donor DU 12 about the establishment of the GTP-U tunnel. The 1st donor CU 14 may include the identity of the second donor DU 22 in the F1AP message. The 1st donor DU 12 may responds, to the 1st donor CU 1, an IP address and TEID (unique tunnel endpoint identifier), which are used to set up GTP-U tunnel between the 1st donor DU 12 and the second donor DU 22.

The 1st donor CU 14 sends an XnAP message to the second donor CU 2 including an IP address and TEID, which are used to set up GTP-U tunnel between the 1st donor DU 12 and the second donor DU 22. The 1st donor CU 14 may also send the identity of the 1st donor DU 12 to the second donor CU 24. The 1st donor CU 14 may include the identity of the second donor DU 22 in the XnAP message as well. Then the second donor CU 24 sends an F1AP message to the second donor DU 22, including, optionally the identity of the first donor DU 12, an IP address and TEID, which are used to set up GTP-U tunnel between the 1st donor DU 12 and the second donor DU 22.

In some implementations, the second donor DU 22 sends, to the second donor CU 24, an IP address and TEID, which are used to set up GTP-U tunnel between the 1st donor DU 12 and the second donor DU 22, via an F1AP message. The second donor CU 24 may respond, to the 1st donor CU 14, an XnAP message that includes at least one of the following:
an IP address and TEID, which are used to set up GTP-U tunnel between the 1st donor DU 12 and the second donor DU 22
identity of first donor-DU 12
identity of second donor-DU 22

Each items above is optional and can be included in or omitted from the configuration based on implementations.

Upon receiving the XnAP message, the 1st donor CU 14 may send, to the 1st donor DU 12, at least one of the following information:
an IP address and TEID, which are used to setup GTP-U tunnel between the 1st donor DU 12 and the second donor DU 22
identity of the second donor DU 22

Each items above is optional and can be included in or omitted from the configuration based on implementations.

The second donor CU 24 determines routing ID of the migrated packet, and sends the routing IDs to the 1st donor CU 22. The 1st donor CU 22 may configure the 1st donor DU so that the packet will be delivered to the neighbouring donor DU via GTP-U tunnel. The configuration performed by the 1st donor CU 22 may include at least one of the following:
a destination IP address, which is indicated by Destination IAB TNL Address IE in IP header information IE, including an IPv4 address or IPv6 address or an IPv6 address prefix,
an IPv6 flow label, if configured, which is indicated by IPv6 Flow Label IE in IP header information IE,
a DSCP, if configured, which is indicated by DSCP IE in DS Information List IE in IP header information IE, and
an indication about whether the packet should be transmitted via GTP-U tunnel between the 1st donor DU 12 and the second donor DU 22.
the identity of the second donor DU 22.

Each items above is optional and can be included in or omitted from the configuration based on implementations.

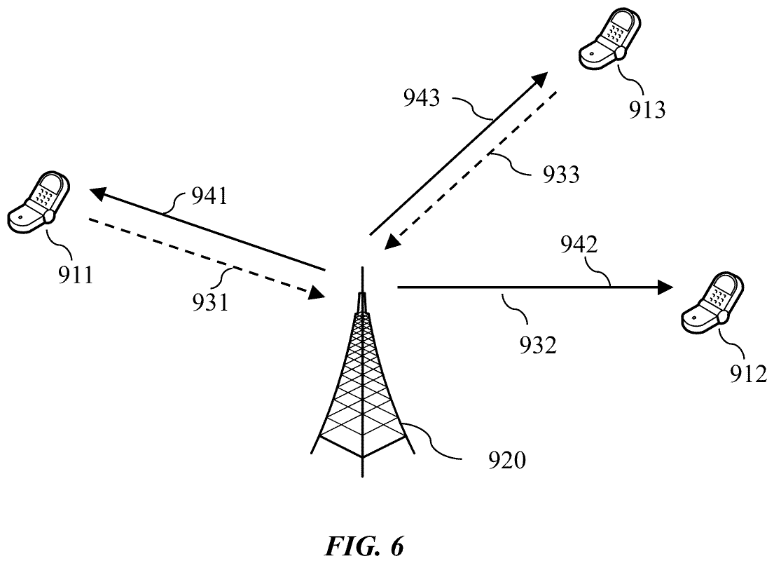

The implementations as discussed above will apply to a wireless communication. FIG. 6 shows an example of a wireless communication system (e.g., a 5G or NR cellular network) that includes a base station 920 and one or more user equipment (UE) 911, 912 and 913. In some embodiments, the UEs access the BS (e.g., the network) using implementations of the disclosed technology 931, 932, 933), which then enables subsequent communication (941, 942, 943) from the BS to the UEs. The UE may be, for example, a smartphone, a tablet, a mobile computer, a machine to machine (M2M) device, an Internet of Things (IoT) device, and so on.

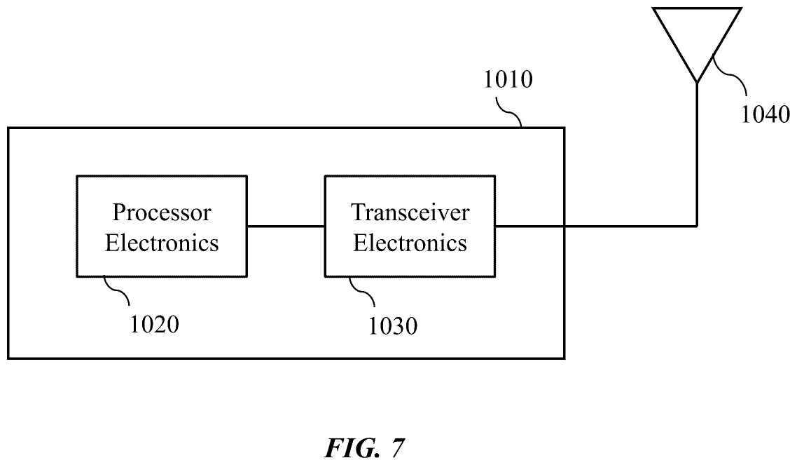

FIG. 7 shows an example of a block diagram representation of a portion of an apparatus. An apparatus 1010 such as a base station or a user device which may be any wireless device (or UE) can include processor electronics 1020 such as a microprocessor that implements one or more of the techniques presented in this document. The apparatus 1010 can include transceiver electronics 1030 to send and/or receive wireless signals over one or more communication interfaces such as antenna 1040. The apparatus 1010 can include other communication interfaces for transmitting and receiving data. The apparatus 1010 can include one or more memories (not explicitly shown) configured to store information such as data and/or instructions. In some implementations, the processor electronics 1020 can include at least a portion of transceiver electronics 1030. In some embodiments, at least some of the disclosed techniques, modules or functions are implemented using the apparatus 1010.

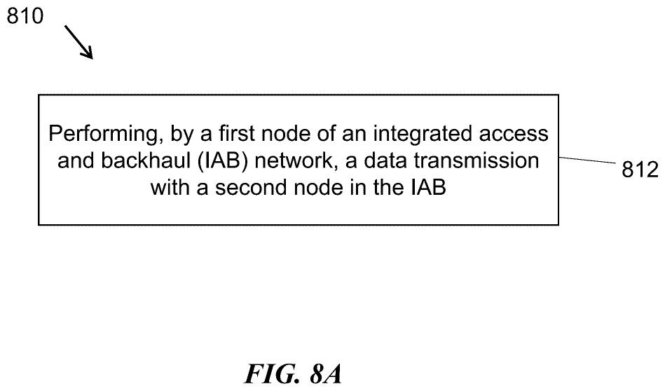

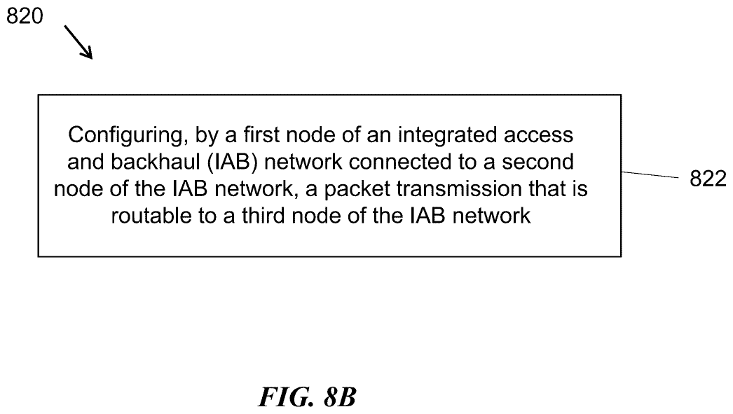

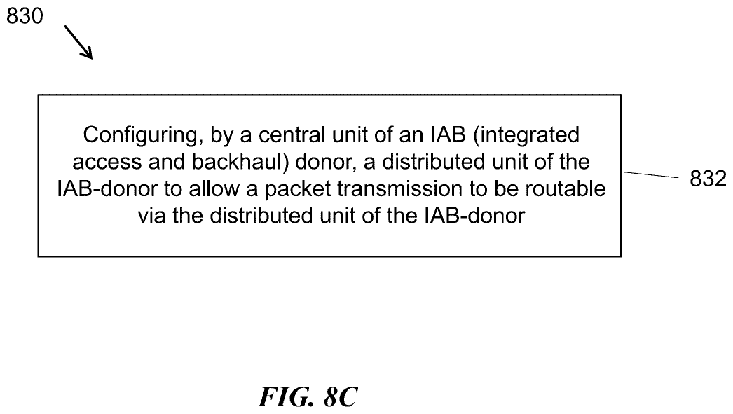

Additional features of the above-described methods/techniques that may be preferably implemented in some implementations are described below using a clause-based description format.
1. A method of wireless communication (e.g., method 810 as shown in FIG. 8A), comprising: performing 812, by a first node of an integrated access and backhaul (IAB) network, a data transmission with a second node in the IAB.
2. The method of clause 1, wherein the data transmission allows data originally scheduled to be transferred via the first node to be transferred via the second node.
3. The method of clause 1, wherein the first node and the second node are configured to access to a same donor CU (central unit)-CP (control plane) or different donor CU-CPs.
4. The method of clause 1, wherein the first node and the second node correspond to distributed units of a same or different IAB donors.
5. The method of clause 1, wherein the first node corresponds to a user plane of a central unit of an IAB donor and the second node corresponds to a distributed unit of a same or different IAB donors.
6. The method of clause 1, further comprising: receiving, by the first node, from a third node of the IAB network that is a central unit of an IAB donor, a configuration information that includes at least one of a first destination internet protocol (IP) address, an IPv6 flow label, a differentiated services code point (DSCP), an indication about whether a packet is transmitted via a tunnel between the first node and the second node, a second destination IP address used for the packet for the data transmission via the tunnel between the first node and the second node, a source IP address used for the packet for the data transmission via the tunnel between the first node and the second node, or an identity of the second node.
7. The method of clause 1, further comprising: receiving, by the first node, from a third node of the IAB network that is a control plane of a central unit of an IAB donor, a configuration information that includes a F1-U tunnel identity, an identity of the second node, an indication about whether a packet is transmitted via a tunnel between the first node and the second node, a destination IP address used for the packet for the data transmission via the tunnel between the first node and the second node, a source IP address used for the packet for the data transmission via the tunnel between the first node and the second node.
8. The method of clause 7, wherein the F1-U tunnel identity is indicated by i) an UE identity and DRB (dedicated radio bearer) identity or ii) a transport layer address and a GTP tunnel endpoint identifier.
9. A method of wireless communication (e.g., 820 as shown in FIG. 8B), comprising: configuring 822, by a first node of an integrated access and backhaul (IAB) network connected to a second node of the IAB network, a packet transmission that is routable to a third node of the IAB network.
10. The method of clause 9, wherein the configuring the packet transmission includes adding or removing of an additional packet header to or from the packet having a packet header, the additional packet header including an address of a destination.
11. The method of clause 10, wherein the first node corresponds to a control plane of a central unit of a first IAB donor, the second node corresponds to a user plane of the central unit of the first IAB donor, and the third node is a distributed unit of a first IAB donor or a second IAB donor.
12. The method of clause 11, further comprising: transmitting an indication informing the second node that the packet requires the adding or the removing of the additional packet header.
13. The method of clause 11, further comprising: transmitting an indication informing the second node that the address is a destination IP address of the additional packet header.
14. The method of clause 9, wherein the first node corresponds to a control plane of a central unit of a first IAB donor, the second node corresponds to an IAB-node, and the third node corresponds to a distributed unit of the first IAB donor or the second IAB donor.
15. The method of clause 14, further comprising: sending, by the first node, configuring information that includes at least one of a backhaul adaptation protocol (BAP) address of a child node of the second node, a ingress or egress backhaul radio link control (RLC) channel information, or a routing identification, or an indication indicating the adding or the removing of the additional packet header.
16. The method of clause 14, further comprising: sending, by the first node, configuration information that includes at least one of a UE bearer identity, or an indication indicating that the packet from the UE bearer needs the adding or the removing of the additional packet header.
17. The method of clause 14, further comprising: receiving, by the first node, from the second node, a report as to whether the second node supports the adding or the removing of the additional packet header.
18. The method of any of clause 17, wherein the reporting is performed via a F1 application protocol (F1AP) message or a radio resource control (RRC) message.
19. A method of wireless communication (e.g., method 830 as shown in FIG. 8C), comprising: configuring 832, by a central unit of an IAB (integrated access and backhaul) donor, a distributed unit of the IAB-donor to allow a packet transmission to be routable via the distributed unit of the IAB-donor.
20. The method of claim 19, wherein the configuring of the distributed unit of the IAB-donor includes sending configuring mapping information that includes at least one of a destination internet protocol (IP) address, an IPv6 flow label, a differentiated services code point (DSCP), or an IP address to be rewritten for the packet transmission.
21. A communication apparatus comprising a processor configured to implement a method recited in any one or more of claims 1 to 20.
22. A computer readable medium having code stored thereon, the code, when executed, causing a processor to implement a method recited in any one or more of claims 1 to 20.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
performing, by a first node of an integrated access and backhaul (IAB) network, a data transmission with a second node in the IAB network,
wherein the data transmission allows data originally scheduled to be transferred via the first node to be transferred via the second node.

2. The method of claim 1, wherein the first node and the second node are configured to access to a same donor CU (central unit)-CP (control plane) or different donor CU-CPs.

3. The method of claim 1, wherein the first node and the second node correspond to distributed units of a same or different IAB donors.

4. The method of claim 1, wherein the first node corresponds to a user plane of a central unit of an IAB donor and the second node corresponds to a distributed unit of a same or different IAB donors.

5. The method of claim 1, further comprising
receiving, by the first node, from a third node of the IAB network that is a central unit of an IAB donor, a configuration information that includes at least one of a first destination internet protocol (IP) address, an IPv6 flow label, a differentiated services code point (DSCP), an indication about whether a packet is transmitted via a tunnel between the first node and the second node, a second destination IP address used for the packet for the data transmission via the tunnel between the first node and the second node, a source IP address used for the packet for the data transmission via the tunnel between the first node and the second node, or an identity of the second node.

6. The method of claim 1, further comprising:
receiving, by the first node, from a third node of the IAB network that is a control plane of a central unit of an IAB donor, a configuration information that includes a F1-U tunnel identity, an identity of the second node, an indication about whether a packet is transmitted via a tunnel between the first node and the second node, a destination IP address used for the packet for the data transmission via the tunnel between the first node and the second node, a source IP address used for the packet for the data transmission via the tunnel between the first node and the second node.

7. The method of claim 6, wherein the F1-U tunnel identity is indicated by i) a UE identity and DRB (dedicated radio bearer) identity or ii) a transport layer address and a GTP tunnel endpoint identifier.

8. The method of claim 1, further comprising:
configuring a distributed unit of an IAB donor to allow a packet transmission to be routable via the distributed unit of the IAB donor, wherein the first node of the IAB network is a central unit of the IAB donor and the configuring of the distributed unit of the IAB donor includes sending configuring mapping information that includes at least one of a destination internet protocol (IP) address, an IPv6 flow label, a differentiated services code point (DSCP), or an IP address to be rewritten for the packet transmission.

9. A method of wireless communication, comprising:
configuring, by a first node of an integrated access and backhaul (IAB) network connected to a second node of the IAB network, a packet transmission that is routable to a third node of the IAB network, wherein the configuring the packet transmission includes adding or removing of an additional packet header to or from a packet having a packet header, the additional packet header including an address of a destination.

10. The method of claim 9, wherein the first node corresponds to a control plane of a central unit of a first IAB donor, the second node corresponds to a user plane of the central unit of the first IAB donor, and the third node is a distributed unit of a first IAB donor or a second IAB donor.

11. The method of claim 10, further comprising: transmitting an indication informing the second node that the packet requires the adding or the removing of the additional packet header.

12. The method of claim 10, further comprising: transmitting an indication informing the second node that the address is a destination IP address of the additional packet header.

13. The method of claim 10, wherein the first node corresponds to a control plane of a central unit of a first IAB donor, the second node corresponds to an IAB-node, and the third node corresponds to a distributed unit of the first IAB donor or the second IAB donor.

14. The method of claim 13, further comprising: sending, by the first node, configuring information that includes at least one of a backhaul adaptation protocol (BAP) address of a child node of the second node, a ingress or egress backhaul radio link control (RLC) channel information, or a routing identification, or an indication indicating the adding or the removing of the additional packet header.

15. The method of claim 13, further comprising: sending, by the first node, configuration information that includes at least one of an identify of a UE bearer, or an indication indicating that the packet from the UE bearer needs the adding or the removing of the additional packet header.

16. The method of claim 13, further comprising:
receiving, by the first node, from the second node, a report as to whether the second node supports the adding or the removing of the additional packet header, wherein the report is received via a F1 application protocol (F1AP) message or a radio resource control (RRC) message.

17. A communication apparatus comprising a processor configured to implement a method comprising:
performing, by a first node of an integrated access and backhaul (IAB) network, a data transmission with a second node in the IAB network, and
wherein the data transmission allows data originally scheduled to be transferred via the first node to be transferred via the second node.

18. The communication apparatus of claim 17, wherein the first node and the second node are configured to access to a same donor CU (central unit)-CP (control plane) or different donor CU-CPs, or wherein the first node and the second node correspond to distributed units of a same or different IAB donors, or wherein the first node corresponds to a user plane of a central unit of an IAB donor and the second node corresponds to a distributed unit of a same or different IAB donors.

19. The communication apparatus of claim 17, further comprising:
receiving, by the first node, from a third node of the IAB network that is a central unit of an IAB donor, a configuration information that includes at least one of a first destination internet protocol (IP) address, an IPv6 flow label, a differentiated services code point (DSCP), an indication about whether a packet is transmitted via a tunnel between the first node and the second node, a second destination IP address used for the packet for the data transmission via the tunnel between the first node and the second node, a source IP address used for the packet for the data transmission via the tunnel between the first node and the second node, or an identity of the second node, or
receiving, by the first node, from a third node of the IAB network that is a control plane of a central unit of an IAB donor, a configuration information that includes a F1-U tunnel identity, an identity of the second node, an indication about whether a packet is transmitted via a tunnel between the first node and the second node, a destination IP address used for the packet for the data transmission via the tunnel between the first node and the second node, a source IP address used for the packet for the data transmission via the tunnel between the first node and the second node.

20. The communication apparatus of claim 17, further comprising:
configuring a distributed unit of an IAB donor to allow a packet transmission to be routable via the distributed unit of the IAB donor, wherein the first node of the IAB network is a central unit of the IAB donor and the configuring of the distributed unit of the IAB donor includes sending configuring mapping information that includes at least one of a destination internet protocol (IP) address, an IPv6 flow label, a differentiated services code point (DSCP), or an IP address to be rewritten for the packet transmission.
